(19) United States
(12) Patent Application Publication
(10) Pub. No.: US 2014/0005890 A1
(43) Pub. Date: Jan. 2, 2014

(54) Control Apparatus Applying Arbitration To Plurality Of Received Control Requests

(71) Applicant: DENSO CORPORATION, Kariya-city (JP)

(72) Inventor: Hideaki TANAKA, Kariya-shi (JP)

(21) Appl. No.: 13/928,625

(22) Filed: Jun. 27, 2013

(30) Foreign Application Priority Data
Jul. 2, 2012 (JP) 2012-148533

(51) Int. Cl. B60G 99/00

(52) U.S. Cl. CPC B60G 99/00
USPC 701/38

(57) ABSTRACT

A control apparatus for a vehicle can receive a plurality of control requests each expressing a requested position and requested attitude angle for the vehicle, the control requests originating from respective control request apparatuses such as driver assistance apparatuses. The control apparatus executes arbitration to select one of the control requests, which is then converted to a corresponding yaw rate control request. The converted yaw rate control request is supplied to a yaw rate control apparatus, which controls the vehicle motion accordingly.

### CROSS-REFERENCE TO RELATED APPLICATIONS

This application is based on and incorporates herein by reference Japanese Patent Application No. 2012-148533 filed on Jul. 2, 2012.

### BACKGROUND OF THE INVENTION

1. Field of Application

The present invention relates to a control apparatus which receives a plurality of control requests and arbitrates these to select a single control request.

2. Background Technology

Types of apparatus have been proposed for controlling the yaw rate of a motor vehicle, for example as in Japanese patent publication No. 2008-94214. With that apparatus, a control quantity required for producing a target value of yaw moment is calculated, and the control quantity is supplied to apparatuses which can change the lateral motion of the vehicle.

However an apparatus such as a driving support apparatus of a vehicle may originate a position/attitude control request (combination of a requested position and requested attitude angle of the vehicle). Examples of such a driving support apparatus are an auto-park system or an autonomous following system. It is necessary to convert such control requests from the dimensions of vehicle position and attitude angle to the dimension of yaw rate. A plurality of such position/attitude control requests may be generated by a plurality of driving support apparatuses. In the prior art it has been necessary to provide an auxiliary control section for performing such yaw rate conversion, in each of the driving support apparatuses.

This will be described more specifically referring to FIG. 7. In this example, numerals 101, 111, 121 designate respective position/attitude control request apparatuses (e.g., driving support apparatuses). These are provided with respective position/attitude control request conversion sections 102, 112 and 122 as auxiliary control sections, for effecting the above-described conversion. Yaw rate control requests which are thereby produced from the position/attitude control request conversion sections 101, 112 and 122 are outputted to a yaw rate control request arbitration section 141 of a yaw rate control platform. In addition, a yaw rate control request apparatus 131 outputs a yaw rate control request to the yaw rate control request arbitration section 141. The yaw rate control request arbitration section 141 performs arbitration processing to select a single yaw rate control request from the received plurality, and supplies the selected control request to a yaw rate request conversion section 151 of the yaw rate control platform. The yaw rate request conversion section 151 responds by producing an assist torque (i.e., steering torque assistance) control request and a braking torque control request, which are respectively supplied to a steering control apparatus 161 and to a braking control apparatus 171. The yaw rate of the vehicle is thereby controlled based on the selected yaw rate control request.

The position/attitude control request apparatuses 101, 111 and 121 are also provided with respective achievable position/attitude range conversion sections 103, 113 and 123. The yaw rate control request apparatus 131 is provided with an achievable yaw rate range conversion section 133.

The steering control apparatus 161 produces information expressing an achievable assist torque range (i.e., range of values of assist torque which can currently be actually realized), and supplies that information to the achievable position/attitude range conversion sections 103, 113 and 123 respectively, and to the achievable yaw rate range conversion section 133. The braking control apparatus 171 produces information expressing an achievable braking torque range (i.e., range of values of braking torque which can currently be actually realized), and supplies that information to the achievable position/attitude range conversion sections 103, 113 and 123 respectively, and to the achievable yaw rate range conversion section 133 of the yaw rate control request apparatus 131.

Each of the achievable position/attitude range conversion sections 103, 113 and 123 converts the achievable assist torque range and the achievable braking torque range to a currently attainable range of vehicle positions and a currently attainable range of vehicle attitude angles, and supplies these to the corresponding one of the position/attitude control request apparatuses 101, 111 and 121. The achievable yaw rate range conversion section 133 converts the achievable assist torque range and the achievable braking torque range to a currently achievable range of yaw rates, and supplies that to the yaw rate control request apparatus 131.

Hence with a prior art design of such a system, each driving support apparatus (control request apparatus) which generates control requests other than yaw rate control requests must be provided with a corresponding auxiliary section (position/attitude request conversion section). Thus if the number of driving support apparatuses is changed, it becomes necessary to also change the number of such auxiliary sections, so that the problem arises of poor design efficiency.

### SUMMARY

Hence it is desired to overcome the above problem, by providing a control apparatus whereby such auxiliary sections can be eliminated, thereby improving design efficiency.

To achieve the above objective the invention provides a control apparatus for installation on a vehicle, comprising an arbitration section which can concurrently receive a plurality of position/attitude control requests from respective control request apparatuses, and select one of these requests. Each position/attitude control request expresses a required position value and a required attitude angle control value.

The control apparatus further comprises a first conversion section, which receives the selected position/attitude control request from the arbitration circuit and converts it to a yaw rate control request, and a yaw rate control apparatus which receives the converted yaw rate control request and applies control of the vehicle motion for implementing the yaw rate control request.

A requested position may be expressed relative to an absolute position, or relative to the current position of the vehicle. Similarly, a requested attitude angle may be expressed relative to an absolute (azimuth) angle, or relative to the current direction of advancement of the vehicle.

Thus with the present invention, a single control request is selected from a plurality of inputted control requests which are each in the dimensions of position and attitude angle, and the selected control request is converted to the dimension of yaw rate. Hence, it becomes unnecessary for each control request apparatus which generates control requests in the dimension of position and attitude angle to be provided with an individually corresponding section for performing conversion to the yaw rate dimension, as is required with the prior art. Thus the required number of yaw rate conversion sections can be fixed, independent of any change made in the number of control request apparatuses which transmit requests in the dimensions of position and attitude angle.

Specifically, with the prior art when respective control requests are supplied to the control apparatus from N position/attitude control request apparatuses (N≧2), a total of N auxiliary sections are required for conversion from the position and attitude angle dimension to the yaw rate dimension, i.e., (N+1) sections including an arbitration section. Hence, if the system design is altered such that the number of position/attitude control request apparatuses is increased, the required number of auxiliary sections increases accordingly.

However with the present invention, the total number of sections required to perform arbitration and perform conversion from the position and attitude angle dimensions to the yaw rate dimension does not exceed a total of 2, irrespective of the number N of position/attitude control request apparatuses for which arbitration must be performed. Thus if N exceeds 2, the required number of auxiliary sections becomes less than is required with the prior art, so that design efficiency is improved.

A position/attitude control request received by the control apparatus may specify (when converted to the yaw rate dimension) a yaw rate which is outside an achievable yaw rate control range, i.e., a range of yaw rate values that can actually be implemented by the yaw rate control apparatus at the current time. Hence, the yaw rate control apparatus is preferably configured for outputting information expressing that achievable yaw rate control range, with the first conversion section being configured to receive that information, to judge when the converted yaw rate control request is outside that range, and adjust the converted yaw rate control request to come within the achievable yaw rate control range, if necessary.

The number of yaw rate control requests which are supplied to the yaw rate control apparatus and which are outside the achievable yaw rate control range can thereby be substantially reduced. If such an out-of-range request is supplied to the yaw rate control apparatus at the current time, the effect will be detected at the next control timing, and processing for correction of that effect will require to be executed. Hence, reducing such out-of-range requests can enhance the control performance.

Furthermore, the control apparatus may further include a second conversion section, for converting the achievable yaw rate control range to an achievable position/attitude range (i.e., an achievable range of position values and an achievable range of attitude angle values) and for supplying information expressing the achievable position/attitude range to the arbitration section. In that case the arbitration section is configured to judge whether the selected position/attitude control request is outside the achievable position/attitude range, and to adjust that control request to come within the achievable position/attitude range if necessary.

This can further reduce the number of out-of-range requests which are acted on, and so further enhance the control performance.

### BRIEF DESCRIPTION OF THE DRAWINGS

FIG. 1 is a system block diagram showing the general configuration of an embodiment of a control platform;

FIG. 2 is a diagram illustrating the position and attitude angle of a vehicle;

FIG. 3 is a flow diagram of processing executed by a position/attitude control request arbitration section of the embodiment;

FIGS. 4A and 4B are timing diagrams for illustrating time-axis variations of control requests which are inputted to the position/attitude control request arbitration section and of a control request that is selected by that arbitration section;

FIG. 5 is a conceptual block diagram for describing the configuration a position/attitude request conversion section of the embodiment;

FIG. 6 is a diagram illustrating a relationship between a variable gain and a displacement amount variation; and,

FIG. 7 is a block diagram showing the general configuration of a prior art example of a control platform.

### DESCRIPTION OF PREFERRED EMBODIMENTS

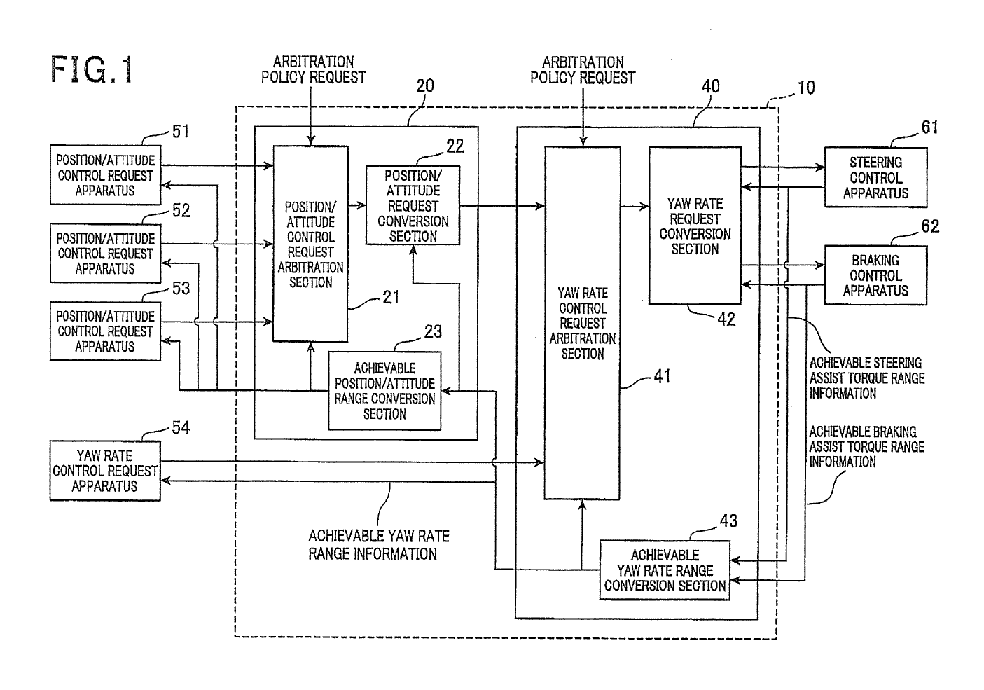

FIG. 1 is a block diagram showing the general configuration of a control platform 10, for installation in a motor vehicle that is equipped with a plurality of position/attitude control request apparatuses 51, 52, 53, a yaw rate control request apparatus 54, a steering control apparatus 61 and a braking control apparatus 62. The position/attitude control request apparatuses 51, 52, 53 respectively produce respective control requests each specifying a requested position and requested attitude angle of the host vehicle, which are inputted to the control platform 10. The yaw rate control request apparatus 54 produces a yaw rate control request which is also inputted to the control platform 10. The control platform 10 arbitrates between the plurality of received control requests and outputs resultant control requests, based on the arbitration, to the steering control apparatus 61 and to the braking control apparatus 62.

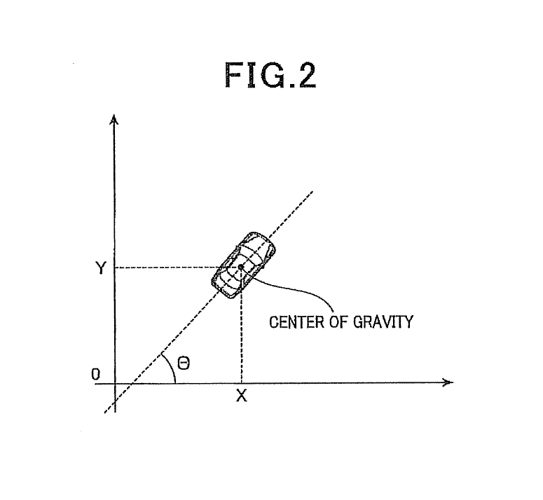

The control objectives of the position/attitude control requests produced from the position/attitude control request apparatuses 51, 52, 53 are in the dimensions of position and attitude angle of the host vehicle. A position control request may designate a required position of the center of mass of the vehicle by XY global coordinates, as illustrated in FIG. 2. However it is equally possible to specify such a position with respect to a previously established reference position, attained at a previously registered time point. An attitude angle control request may specify a required attitude angle of the vehicle by XY global coordinates, e.g., as an angle θ between the X-axis and the straight-ahead direction of the vehicle at the current time, as illustrated in FIG. 2. However it would be equally possible to specify an angular difference with respect to the heading direction attained by the vehicle at a preceding reference time point. With this embodiment, each position/attitude control request produced from the position/attitude control request apparatuses 51, 52, 53 contains a combination of such a position control request and attitude angle control request.

Each position/attitude control request from the position/attitude control request apparatuses 51, 52, 53 also includes information specifying a maximum allowable yaw rate and a minimum allowable yaw rate. These values are determined as being allowable with respect to the standpoint of the position/attitude control request apparatus 51, 52 or 53 which issues that position/attitude control request.

Specific examples of the position/attitude control request apparatuses 51, 52, 53 are an auto-park system, an autonomous vehicle following system, an autonomous lane following system, etc.

The yaw rate control request apparatus 54 produces control requests having yaw rate as the dimension of the control objective. Specific examples of the yaw rate control request apparatus 54 include a side-wind handling system, a side-skid prevention system, etc. Each yaw rate control request produced from the yaw rate control request apparatus 54 also includes information specifying maximum and minimum values of allowable yaw rate.

As shown in FIG. 1, the control platform 10 is basically formed of a position/attitude control platform 20 and a yaw rate control platform 40. The position/attitude control platform 20 includes a position/attitude control request arbitration section 21, a position/attitude request conversion section 22 and an achievable position/attitude range conversion section 23. The yaw rate control platform 40 includes a yaw rate control request arbitration section 41, a yaw rate request conversion section 42 and an achievable yaw rate range conversion section 43.

The position/attitude control request arbitration section 21 receives the plurality of position/attitude control requests from the position/attitude control request apparatuses 51, 52, 53 and arbitrates between these. Specifically, one of the position/attitude control requests is selected in accordance with an arbitration policy, which is specified by an externally supplied arbitration policy request. The position/attitude control request arbitration section 21 adjusts the selected position/attitude control request such that the requested position value and requests attitude angle value thereof will respectively be within an achievable position range and achievable attitude angle range (referred to collectively as the achievable position/attitude range in the following). Information specifying the achievable position/attitude range is supplied from the achievable position/attitude range conversion section 23.

With this embodiment, the arbitration policy applied by the position/attitude control request arbitration section 21 is as follows. When a single position/attitude control request is received from a position/attitude control request apparatus of a safety system of the vehicle, that request is selected with priority. If there are a plurality of position/attitude control requests and none of these originates from a safety system, the position/attitude control request which requests (i.e., will result in) a maximum amount of position displacement is selected. If there are a plurality of position/attitude control requests which originate from respective control request apparatuses of the safety system, the highest-priority one of these is selected (in accordance with a predetermined policy concerning the control request apparatuses of the safety system).

However it would be equally possible to modify the arbitration policy in accordance with factors such as conditions of the vehicle and/or the vehicle occupants.

After adjusting the values in the selected position/attitude control request to be within the achievable position/attitude range as described above, the position/attitude control request arbitration section 21 supplies the resultant adjusted position/attitude control request to the position/attitude request conversion section 22, to be converted to a yaw rate control request. The position/attitude request conversion section 22 performs PID (proportional-integral-derivative) FF (feed-forward) control and FB (feedback) control based on the position/attitude control request supplied from the position/attitude control request arbitration section 21, for conversion to a yaw rate control request that is within an achievable yaw rate range (specified by the achievable yaw rate range conversion section 43 as described hereinafter).

The achievable position/attitude range conversion section 23 converts the achievable yaw rate range (supplied from the achievable yaw rate range conversion section 43 of the yaw rate control platform 40) to the aforementioned achievable position/attitude range, based on the achievable yaw rate range, characteristics of the vehicle (stored beforehand as a model in a memory), the current position of the vehicle (information detected by a sensor), and the current attitude angle of the vehicle (information detected by a sensor).

The yaw rate control request arbitration section 41 of the yaw rate control platform 40 can receive a plurality of yaw rate control requests and apply arbitration to these, for outputting a resultant yaw rate control request. Specifically, the yaw rate control request arbitration section 41 selects one of the yaw rate control requests that are respectively outputted from the position/attitude control request arbitration section 21 and the yaw rate control request apparatus 54, with the selection performed based on an externally supplied arbitration policy request. The yaw rate control request arbitration section 41 then (if necessary) adjusts the selected yaw rate control request to be within the aforementioned achievable yaw rate range, and outputs the resultant yaw rate control request to the yaw rate request conversion section 42.

The yaw rate request conversion section 42 converts that yaw rate control request to a steering assist torque request and a braking torque request, by executing PID FF and FB control based on the yaw rate control request. The steering assist torque request is supplied to a steering control apparatus 61 and the braking torque request is supplied to a braking control apparatus 62.

The achievable yaw rate range conversion section 43 converts an achievable steering assist torque range (expressed by information from the steering control apparatus 61) and an achievable braking torque range (expressed by information from the braking control apparatus 62) to the aforementioned achievable yaw rate range. Specifically, the achievable yaw rate range conversion section 43 calculates the achievable yaw rate range based upon the achievable steering assist torque range, the achievable braking torque range, characteristics of the host vehicle (stored beforehand as a model in a memory), and the yaw rate at the current time (detected by a sensor).

The yaw rate request conversion section 42 repetitively (with a control period of several msecs) outputs steering assist torque requests, and the steering control apparatus 61 responds accordingly by controlling a degree of steering assist force such as to realize the requested value of steering assist torque, with the steering assist torque being within the achievable steering assist torque range. The steering control apparatus 61 expresses the achievable steering assist torque range as an upper limit value and lower limit value of a currently actually achievable range of steering assist torque. Similarly, the braking control apparatus 62 expresses the achievable braking torque range as an upper limit value and lower limit value of a currently actually achievable range of braking torque.

Based on the achievable steering assist torque range supplied from the steering control apparatus 61, the achievable braking torque range supplied from the braking control apparatus 62, the vehicle characteristics, and the yaw rate at the current time, the achievable yaw rate range conversion section 43 calculates the (currently) achievable yaw rate range. The achievable yaw rate range is supplied to the yaw rate control request arbitration section 41, to the position/attitude request conversion section 22 and the achievable position/attitude range conversion section 23 of the position/attitude control platform 20, and to the yaw rate control request apparatus 54. Based on that achievable yaw rate range, the yaw rate control request apparatus 54 calculates a requested yaw rate, which is outputted in a yaw rate control request to the yaw rate control request arbitration section 41.

The achievable position/attitude range conversion section 23 receives information expressing the achievable yaw rate range from the achievable yaw rate range conversion section 43, the vehicle characteristics, the current position of the vehicle and the current attitude angle of the vehicle, and uses the information to calculate the achievable position/attitude range. Information expressing the achievable position/attitude range is supplied to the position/attitude control request arbitration section 21 and to each of the position/attitude control request apparatuses 51, 52, 53. The position/attitude control request apparatuses 51, 62, 53 calculate respective requested positions and attitude angles based on the achievable position/attitude range, and thereby produce respective position/attitude control requests which are inputted to the position/attitude control request arbitration section 21 of the position/attitude control platform 20 as described above.

The control platform 10 of this embodiment is configured as an ECU (electronic control unit) based on a microcomputer, which is installed on the host vehicle, with the respective functions of the position/attitude control platform 20 and of the yaw rate control platform 40 being performed by execution of modules of a program which is held stored in a non-volatile memory of the microcomputer. Hence there are no specific limitations upon the hardware configuration of the control platform 10. Furthermore it would be equally possible for the functions of the position/attitude control platform 20 and of the yaw rate control platform 40 to be performed by execution of respective programs by microcomputers of two or more separate ECUs. Similarly, the functions of the position/attitude control request apparatuses 51, 52, 53 may be performed through execution of modules of a single program which is held stored in a non-volatile memory of a microcomputer, or through execution of programs by respectively different microcomputers, so that there are no specific limitations upon the hardware configuration of the position/attitude control request apparatuses 51, 52, 53.

### Description of Operation

The operation of specific sections of the control platform 10 is described in the following.

### (1) Position/Attitude Control Request Arbitration Section 21 of Position/Attitude Control Platform 20

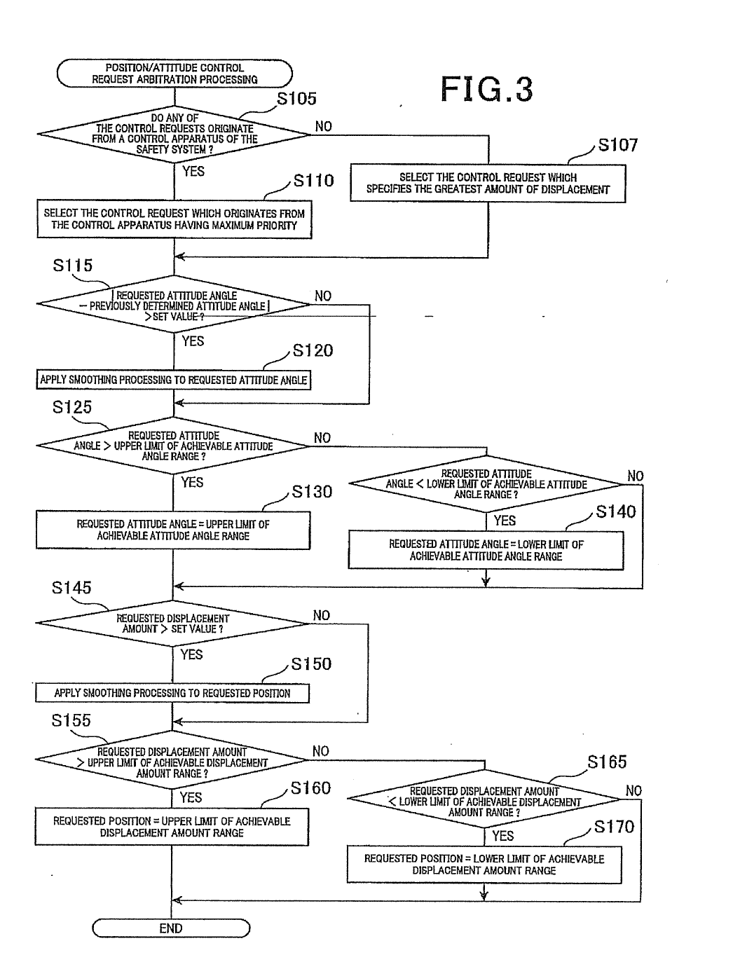

The arbitration processing performed by the position/attitude control request arbitration section 21 will be described referring to the flow diagram of FIG. 3. The processing routine shown in FIG. 3 is repetitively executed, and will be described assuming that a plurality of position/attitude control requests are received by the position/attitude control request arbitration section 21 from the position/attitude control request apparatuses 51, 52 and 53 respectively. Firstly in step S105 a decision is made as to whether the received requests include a request from a position/attitude control request apparatus of a safety system of the host vehicle. Recognition of a position/attitude control request apparatus of a safety system is performed in a predetermined manner, based on characteristics of such an apparatus (such as the effects, with respect to safety, of driver support that is realized by the apparatus).

If it is judged in step S105 that the position/attitude control requests include one or more requests from position/attitude control request apparatuses of the safety system, step S110 is then executed. In step S110, if there is a single request from a position/attitude control request apparatus of the safety system then that is selected, while if there are a plurality of such requests, the request having highest priority is selected. With this embodiment, only one of two levels of priority can be assigned, i.e., “high” or “low”. However the invention is not limited to this, and it would be equally possible to employ three or more priority levels.

If it is judged in step S105 that the received position/attitude control requests do not include any request from a position/attitude control request apparatus of the safety system, step S107 is then executed. In step S107, the position/attitude control request which requires the greatest amount of (position) displacement is selected. Following execution of step S110 or step S107, step S115 is then executed.

If requested positions are expressed in absolute coordinates, then the amount of displacement is calculated as the difference between the position specified in the currently selected position/attitude control request and the position specified by the precedingly selected request. If requested positions are expressed as relative positions, then the amount of displacement is obtained as the distance between the position specified in the currently selected position/attitude control request and the position specified by the precedingly selected request (as an origin point).

In step S115 a decision is made as to whether an absolute value of attitude angle difference exceeds a predetermined set value. Here, the attitude angle difference is the difference between the currently requested attitude angle (i.e., specified by the currently selected position/attitude control request) and the precedingly requested attitude angle (whose value was obtained in the preceding execution of the processing of FIG. 3). The value of that precedingly requested attitude angle is stored in a memory of the position/attitude control request arbitration section 21. The set value of attitude angle difference is predetermined such that, if the value were to be exceeded, problems might arise with respect to the vehicle stability or the comfort of the vehicle occupants.

If it is judged in step S115 that the absolute value of attitude angle difference exceeds the predetermined set value, then step S120 is executed in which smoothing processing (filter processing) is initiated. Specifically, the requested attitude angle value (as outputted to the position/attitude request conversion section 22) is gradually increased or decreased, as appropriate, to finally attain the attitude angle value specified by the currently selected position/attitude control request. This ensures that the requested attitude angle which is actually applied in controlling the vehicle will change only gradually. Step S125 is then executed.

However if it is judged in step S115 that the absolute value of attitude angle difference does not exceed the predetermined set value, step S125 is executed directly, with step S120 being skipped.

In step S125 a decision is made as to whether the requested attitude angle (after smoothing processing, if applied) exceeds the upper limit of the achievable attitude angle range.

If the requested attitude angle is judged to exceed that upper limit, step S130 is then executed in which the upper limit value of the achievable attitude angle range is set as the requested attitude angle. It is thereby ensured that the requested attitude angle is within the achievable attitude angle range. Operation then proceeds to step S145.

However if it is judged in step S125 that the currently requested attitude angle does not exceed the upper limit of the achievable attitude angle range, step S135 is then executed, in which a decision is made as to whether the requested attitude angle (after smoothing processing, if applied) is less than the lower limit of the achievable attitude angle range.

If it is judged in step S135 that the requested attitude angle is less than that lower limit, step S140 is then executed in which the lower limit of the achievable attitude angle range is set as the requested attitude angle. It is thereby ensured that the requested attitude angle is within the achievable attitude angle range. Operation then proceeds to step S145.

However if it is judged in step S135 that the requested attitude angle is not less than the lower limit value of the achievable attitude angle range, step S145 is then executed, with step S140 being skipped.

In step S145, a decision is made as to whether the requested position displacement amount (as defined hereinabove), specified by the position/attitude control request selected in step S107 or S110, exceeds a predetermined set value. The set value is predetermined such that, if it is exceeded, problems might arise with respect to the vehicle stability or the comfort of the vehicle occupants.

If it is judged in step S145 that the requested position displacement amount exceeds the set value, step S150 is then executed, in which smoothing processing is initiated. This is performed (i.e., by gradual variation of requested position values which are outputted from the position/attitude control request arbitration section 21) in the same manner as described above for smoothing of the requested attitude angle values. Step S155 is then executed.

However if it is judged in step S145 that the requested position displacement amount does not exceed the set value, step S155 is then executed directly, with step S150 being skipped.

In step S155 a decision is made as to whether the requested position displacement amount exceeds the upper limit of the achievable displacement amount range (specified by the achievable position/attitude range conversion section 23.

If it is judged in step S155 that the requested displacement amount exceeds the upper limit of the achievable displacement amount range, operation then proceeds to step S160. In step S160, the requested position is changed to a position which is distant from the current position as far as possible while maintaining the position displacement amount within the achievable displacement amount range (i.e., the position displacement amount is set equal to the upper limit of that range), and which lies on the direction between the current position of the vehicle and the position that is requested by the selected position/attitude control request.

However if it is judged in step S155 that the requested displacement amount will not exceed the upper limit of the achievable displacement amount range, step S165 is then executed to judge whether the requested displacement amount is smaller than the lower limit of the achievable displacement amount range.

If it is judged in step S165 that the requested displacement amount is less than the lower limit of the achievable displacement amount range, step S170 is then executed. In step S170, the requested position is changed to be as close as possible to the current position (i.e., such that the position displacement will be the lower limit value of the achievable displacement amount range), while lying on the direction between the current position of the vehicle and the position that is requested by the selected position/attitude control request.

However if it is judged in step S165 that the requested displacement amount is not less than the lower limit value of the achievable displacement amount range, execution of the processing routine is then ended.

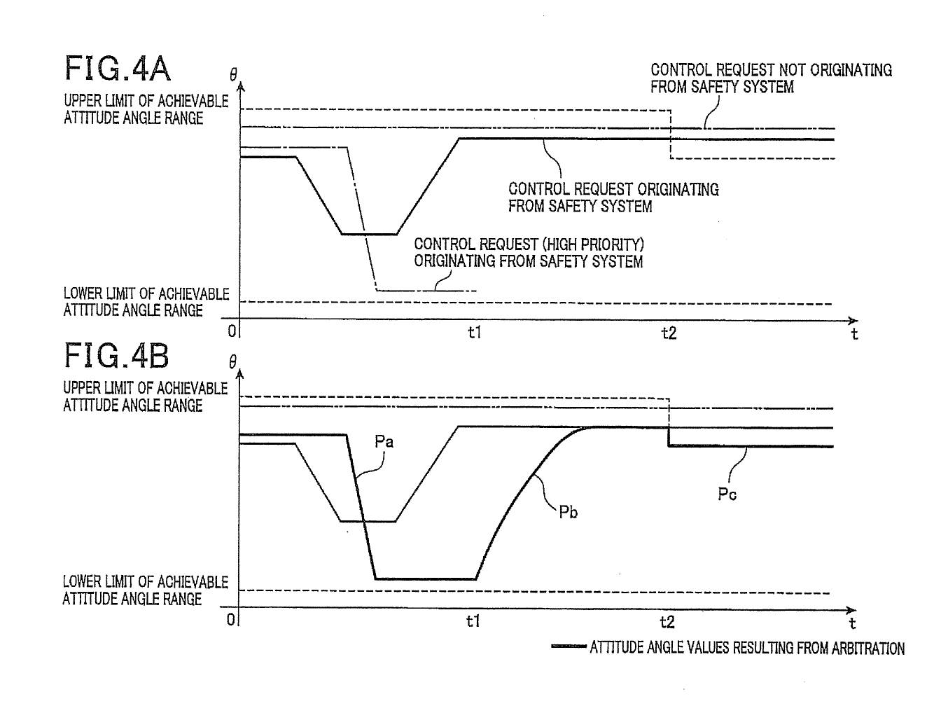

FIG. 4A is a timing diagram showing an example of time-axis variation of attitude angle values specified by respective ones of a plurality of position/attitude control requests which are inputted to the position/attitude control request arbitration section 21, while FIG. 4B shows corresponding results of arbitration by the position/attitude control request arbitration section 21, i.e., results obtained from successive executions of the processing routine of FIG. 3. In FIGS. 4A, 4B time is plotted along the horizontal axis and attitude angle along the vertical axis.

The full-line portion in FIG. 4A illustrates the variation of the attitude angle specified by a position/attitude control request from a first position/attitude control request apparatus of a safety system of the host vehicle. The single-dot chain line portion in FIG. 4A similarly illustrates the variation of requested attitude angle of a position/attitude control request from a second position/attitude control request apparatus of the safety system. The double-dot chain line portion in FIG. 4A illustrates the variation of requested attitude angle specified by a position/attitude control request from a third position/attitude control request apparatus, which is of a vehicle system other than the safety system. The two (upper and lower) broken-line portions respectively illustrate the variation of the upper limit of the achievable attitude angle range and of the lower limit of that range.

With this example, the attitude angle request from the second position/attitude control request apparatus (single-dot chain line portion) is terminated at a time point t1 as shown.

In FIG. 4B, the thick line portion illustrates the results of applying arbitration to the request contents shown in FIG. 4A, i.e., illustrates the requested attitude angle values which are outputted from the position/attitude control request arbitration section 21. It is assumed that the second position/attitude control request apparatus has the highest priority. The portions (A) to (C) indicated in FIG. 4B are described in the following.

(A) The position/attitude control request arbitration section 21 continuously selects the requested attitude angle values originating from that apparatus, so long as the request continues and the condition of priority is maintained. This corresponds to processing of steps S105 to S110 of FIG. 3 above.

(B) At time point t1, when the request from the second position/attitude control request apparatus is terminated, the position/attitude control request arbitration section 21 selects the attitude angle values of the position/attitude control request from the first position/attitude control request apparatus (which is also of the safety system, full-line portion in FIG. 4A). This will result in a sudden large change in requested attitude angle value. Hence, smoothing processing is applied as described hereinabove, to produce a gradual transition to the requested attitude angle value requested by the first position/attitude control request apparatus. This corresponds to the processing of steps S115, S120 of FIG. 3 above.

(C) At time point t2, the upper limit value of the achievable attitude angle range becomes lowered. As a result, the requested attitude angle values from the first position/attitude control request apparatus become greater than the upper limit of the achievable attitude angle range. Hence these attitude angle values are reduced by being limited to the upper limit value of the achievable attitude angle range, to ensure that the achievable attitude angle range is not exceeded. This corresponds to the processing of steps S125 to S140 of FIG. 3 above.

(2) Position/Attitude Request Conversion Section 22 of Position/Attitude Control Platform 20

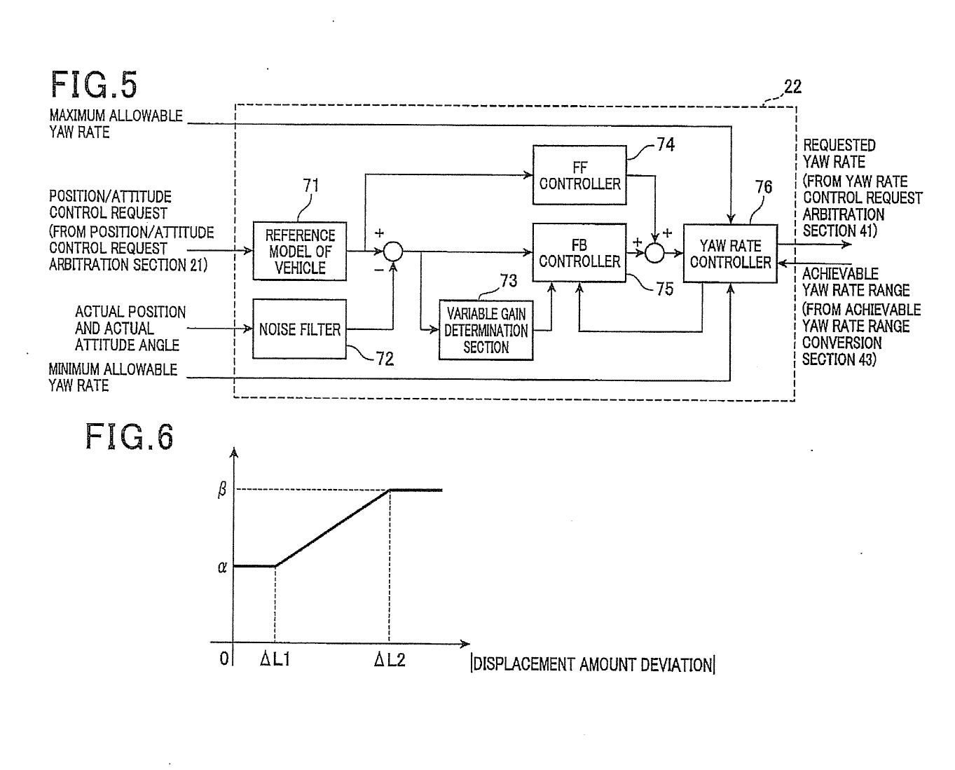

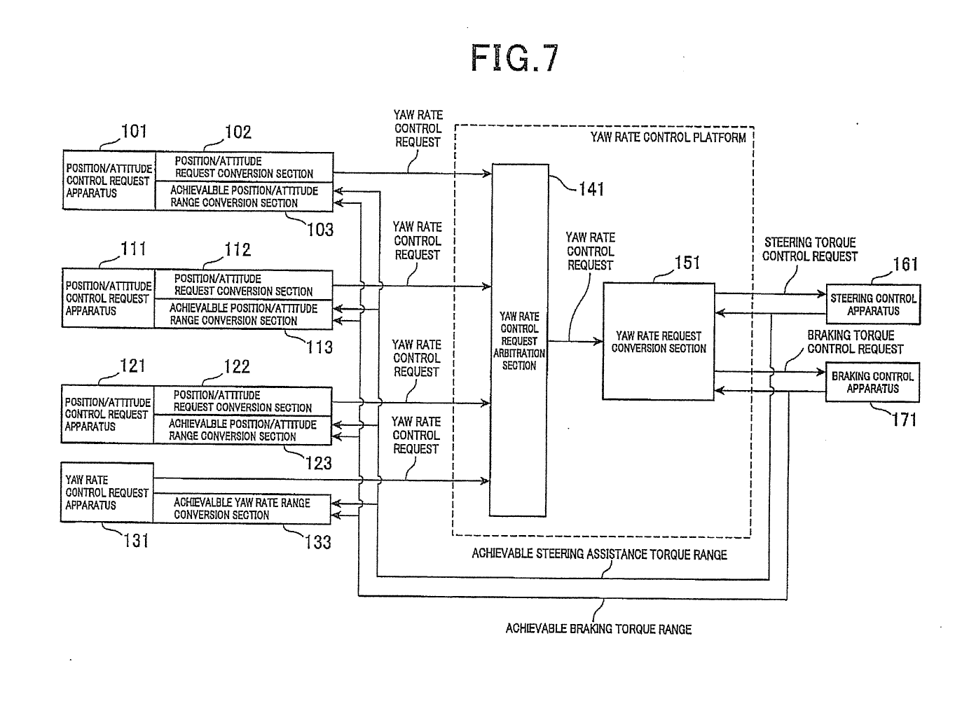

The operation of the position/attitude request conversion section 22 is described in the following, referring to the conceptual block diagram of FIG. 5. The functions of this section are performed by execution of a program which is stored in an internal memory of the position/attitude control platform 20.

As shown in the FIG. 5 the position/attitude request conversion section 22 basically consists of a reference vehicle model section 71, a noise filter section 72, a variable gain determination section 73, a FF controller 74, a FB controller 75 and a yaw rate controller 76. The reference vehicle model section 71 applies filter processing respectively to the requested attitude angle and position values which are specified by the currently selected position/attitude control request (i.e., values which have been modified by limiting and/or smoothing processing if necessary). This filter processing is of a similar order to a frequency response characteristic of the yaw rate control platform 40.

The noise filter 72 applies noise filtering to eliminate random noise from actual values of the vehicle attitude angle and vehicle position, which are received from sensors such as a speed sensor etc., of the host vehicle.

The variable gain determination section 73 determines a first variable gain value (to be applied by the FB controller 75 as described hereinafter), in accordance with the extent of deviation between the requested position value as produced from the reference vehicle model 71 and the actual position value, produced from the noise filter 72. This serves to ensure that control convergence will not be lost, i.e., to ensure that requested yaw rate values will not have a time-axis resolution which is greater than the resolution (control period) of the yaw rate control. The first variable gain value is determined in accordance with the amount of displacement deviation between the requested position as produced from the reference vehicle model 71 and the actual position of the vehicle as produced from the noise filter 72. Specifically, for example as shown in FIG. 6, if the amount of displacement deviation does not exceed a threshold value ΔL1, then the first variable gain value is set as α, while if the amount of displacement deviation exceeds a threshold value ΔL2 (>ΔL1) then the first variable gain value is set as β. If the amount of displacement deviation is between ΔL1 and ΔL2, then the first variable gain value is determined by linear interpolation between α and β.

A second variable gain value is similarly determined for application by the FB controller 75 to the attitude angle values.

For simplicity of description, no distinction is shown in FIG. 5 between processing of position values and of attitude angle values.

The FF controller 74 calculates a requested yaw rate, based on the results of multiplying the requested position and requested attitude angle values (as outputted from the reference vehicle model 71) by respective proportional gain values, and outputs the result as the FF requested yaw rate.

The FB controller 75 multiplies the deviation between the requested position (outputted from the reference vehicle model 71) and the actual position (from the noise filter 72) by the first variable gain value, and multiplies the deviation between the requested attitude angle (outputted from the reference vehicle model 71) and the actual attitude angle (from the noise filter 72) by the second variable gain value. Feedback control (with this embodiment, PID control) is applied to the resultant position values and attitude angle values, and a yaw rate value is calculated from these and is outputted as the FB requested yaw rate.

However if either of the two following conditions (1) or (2) occurs, exception processing is be applied accordingly to the integration processing of the PID control, as follows:

(1) If the processing limitation status of the yaw rate controller 76 (described hereinafter) enters the ON state, the integration processing is immediately halted, and the integration value (integration result) which has been attained by that time is stored. Subsequently, when the processing limitation status of the yaw rate controller 76 returns to the OFF state, the integration processing is recommenced, using the stored integration value as the initial value.

As indicated in FIG. 5, information specifying the processing limitation status is supplied from the yaw rate controller 76 to the FB controller 75.

(2) If the variable gain value becomes α, then the integration processing is halted and the integration value is set to zero. Subsequently, when the variable gain attains a value other than α, the integration processing is recommenced, using zero as the initial value. It should be noted that it is possible to set α as zero.

The yaw rate controller 76 limits the sum of the FF requested yaw rate and the FB requested yaw rate (that sum value being referred to in the following as the pre-limitation requested yaw rate) to be between the minimum allowable yaw rate and the maximum allowable yaw rate, while also being within the achievable yaw rate range (specified by the achievable yaw rate range conversion section 43 as described above). The minimum allowable yaw rate and maximum allowable yaw rate values are specified as part of the information constituting the position/attitude control request which is received by the position/attitude request conversion section 22 from the position/attitude control request arbitration section 21.

Specifically, the following processing is applied, in which MAX (A, B) signifies the larger one of two values A and B, while MIN (A, B) signifies the smaller one of the values A and B:

If [pre-limitation requested yaw rate]<MAX ([minimum allowable yaw rate], [lower limit value of achievable yaw rate range]), then

[requested yaw rate]=MAX ([minimum allowable yaw rate], [lower limit value of achievable yaw rate range]), and

processing limitation status=ON state

If MAX ([minimum allowable yaw rate], [lower limit value of achievable yaw rate range])≦[pre-limitation requested yaw rate]≦MIN ([maximum allowable yaw rate], [upper limit value of achievable yaw rate range]), then

[requested yaw rate]=pre-limitation requested yaw rate, and

processing limitation status=OFF state

If [pre-limitation requested yaw rate]>MIN ([maximum allowable yaw rate], [upper limit value of achievable yaw rate range]), then

[requested yaw rate]=MIN ([maximum allowable yaw rate], [lower limit value of achievable yaw rate range]), and

processing limitation status=ON state

The requested yaw rate which is thus calculated is outputted to the yaw rate control platform 40.

### Effects Obtained by Embodiment

With the control platform 10 of the above embodiment, the position/attitude control platform 20 arbitrates between position/attitude control requests which are received from respectively from a plurality of control request apparatuses 51, 52, 53, to select a single request. It is thereby ensured that the number of control sections (other than position/attitude control request apparatuses) required in the system can be held fixed, irrespective of the number of position/attitude control request apparatuses. Hence, design efficiency is enhanced.

Furthermore with the above embodiment, if a plurality of position/attitude control requests are received and these include a request from a position/attitude control apparatus of a safety system, that request is selected with priority by the position/attitude control request arbitration section 21. It can thereby be ensured that arbitration of control requests is performed without adverse effects upon safety.

Furthermore when a position/attitude control request is newly selected by the position/attitude control request arbitration section 21, if a resultant amount of alteration from the position or attitude angle requested by the precedingly selected control request exceeds a predetermined set value, smoothing processing is applied. This ensures a gradual transition to the newly requested position and attitude angle values, preventing abrupt changes in the motion of the host vehicle.

Furthermore, if a position control request or an attitude control request which is specified by the currently selected position/attitude control request is outside a range which is specified by the achievable position/attitude range conversion section 23, the position/attitude control request arbitration section 21 adjusts the control request to come within the range concerned.

Moreover with the operation of the position/attitude request conversion section 22, if a yaw rate control request is outside the range which is specified by the achievable yaw rate range conversion section 43, the requested yaw rate is adjusted to come within that range.

Hence there is a reduced occurrence of a condition whereby a control request is inputted to the steering control apparatus 61 (or to the braking control apparatus 62) which cannot be executed, and whereby that condition is detected at the next control timing and correction processing must then be performed. Hence, an improvement in control response can be expected.

With respect to the appended claims: a plurality of control request apparatuses recited in the claims corresponds to the position/attitude control requests 51, 52, 53 of the preferred embodiment; an arbitration section corresponds to the arbitration section 21 of the embodiment; a first conversion section corresponds to a position/attitude request conversion section 22 of the embodiment; a yaw rate control apparatus corresponds to a combination of the yaw rate control platform 40, the steering control apparatus 61 and the braking control apparatus 62; a second conversion section corresponds to the achievable is position/attitude range conversion section 23 of the embodiment.

### Other Embodiments

The invention is not limited to the above embodiment, and various modifications or alternative forms may be envisaged. Examples are as follows.

(1) With the arbitration performed by the above embodiment, a single control request is selected from a plurality of inputted control requests. However it would be equally possible for example to obtain a single control request by applying averaging of all of the inputted position/attitude control requests, i.e., taking the average of the respectively requested values of position and the average of the respectively requested values of attitude angle.

(2) It would be equally possible to supply steering control requests to the steering control apparatus 61, instead of steering assistance control requests. That is to say, the steering control apparatus 61 would be controlled such as to realize a requested steering angle.

Furthermore it would be possible to omit the steering control apparatus 61 or the braking control apparatus 62, or to employ additional control apparatuses (such as a left-right torque distribution apparatus, etc.), with appropriate control requests being inputted to such a control apparatuses.

What is claimed is:

1. A control apparatus for installation on a vehicle, comprising:
an arbitration section coupled to receive a plurality of position/attitude control requests produced respectively from a plurality of control request apparatuses, and for selecting and outputting one of the position/attitude control requests, each of the position/attitude control requests expressing a position control request and an attitude angle control request;
a first conversion section, configured for converting the selected position/attitude control request to a converted yaw rate control request; and
a yaw rate control apparatus configured to receive the converted yaw rate control request and to effect yaw rate control of the vehicle in accordance with the received request.

2. A control apparatus according to claim 1, wherein:
the yaw rate control apparatus is configured for outputting information expressing an achievable yaw rate control range as a range within which control can actually be effected by the yaw rate control apparatus; and
when the first conversion section is configured for judging when the converted yaw rate control request is outside the achievable yaw rate control range, for adjusting the converted yaw rate control request to come within the achievable yaw rate control range, and outputting a resultant yaw rate control request to the yaw rate control apparatus.

3. A control apparatus according to claim 2, comprising a second conversion section configured for
converting the achievable yaw rate control range to an achievable position/attitude range, the achievable position/attitude range comprising a currently achievable range of positions of the vehicle and a currently achievable range of attitude angles of the vehicle, and
supplying information expressing the achievable position/attitude range to the arbitration section;
wherein the arbitration section is configured for judging when the selected position/attitude control request is outside the achievable position/attitude range, adjusting the selected position/attitude control request to come within the achievable position/attitude range when judged to be outside that range, and outputting a resultant position/attitude control request to the first conversion section.

4. A control apparatus according to claim 3, wherein the second conversion section is configured for transmitting the information expressing the achievable position/attitude range to each of the plurality of control request apparatuses.

5. A control apparatus according to claim 1, wherein the arbitration section is configured
to judge a difference between a first control quantity, specified by a precedingly selected control request, and a second control quantity, specified by the currently selected control request, and
when the difference is judged to exceed a predetermined set value, to execute smoothing processing for producing successive values of control quantity which gradually vary from the value of the second control quantity to the value of the first control quantity, and to supply the successive values of control quantity to the first conversion section;
for thereby effecting a gradual transition to the control quantity that is specified by the currently selected control request.

6. A control apparatus according to claim 1, comprising a microcomputer having a non-volatile memory with a program stored beforehand in the memory, wherein respective functions of the control apparatus are performed through execution of the program by the microcomputer.
